(19) United States
(12) Patent Application Publication
(10) Pub. No.: US 2012/0176219 A1
(43) Pub. Date: Jul. 12, 2012

(54) ACCESS IDENTIFICATION AND CONTROL DEVICE

(76) Inventors: Massimo Fiorucci, Albavilla (Como) (IT); Roberto Simonin, Albavilla (Como) (IT)

(21) Appl. No.: 12/998,892

(22) PCT Filed: Dec. 12, 2008
(86) PCT No.: PCT/IT2008/000759

§ 371 Date: Jul. 5, 2011

(51) Int. Cl. G05B 19/00

(52) U.S. Cl. 340/5.61

(57) ABSTRACT

An access identification and control device, especially suitable for being used for all those applications wherein the use of an apparatus or a service must be allowed only to the users that have the requirements imposed by the apparatus/service itself or if a check must be carried out on an apparatus or service, including at least one fixed part or reader (2) and at least one mobile part or transponder (50) that can communicate with each other in both directions, low power radio transmitters for carrying out the communication, a two-way radio antenna or element (24) defined by the body of a user that constitutes an extension of the receiving antenna in the communication between fixed part and mobile part, the device wherein the fixed part (2) and the mobile part (50) include communication elements defined by data ciphering algorithms and ciphering keys not known beforehand, each time different and suitable for identifying the mobile part (50) only if the same has been previously stored to the reader or fixed part (2).

### TECHNICAL FIELD

This invention relates to an access identification and control device. More in particular, this invention relates to an access identification and control device especially suitable for being used for all those applications wherein the use of an apparatus or service must be allowed only to the users that have the requirements imposed by the apparatus/service itself or in cases a user must be identified, or yet more, in case a check must be carried out on an apparatus or service.

### BACKGROUND ART

Devices of this type are generally represented by the devices provided with a “transponder” (transmitter responder), that is, an automatic device that generates a signal in response to a specific query; said transponder device allows the transmission of a message in response to a message received.

The fields of application and use of an access identification and control device are several and are preferably but not exclusively related to the field of safety such as antitheft devices for cars, houses and the like.

As is known, the devices for enabling access services and control using two-way radios or transponders are typically composed of a fixed part and a mobile part, both composed of a transmitting part and a receiving part that communicate with each other using radio waves transmitted in both directions (from the fixed part to the mobile part and vice versa) also using the user's body located close to the apparatus to be enabled as an antenna. The user's body therefore defines an extension of the receiving antenna in the communication between the mobile part or parts and the fixed part or parts; such communication is carried by the user's body by contact or, that failing, by passive or induced irradiation.

The fixed part of such devices is constructed so as to communicate with multiple mobile parts owned by the user by means of the transmission and reception of very low power radio waves; said fixed part radiates a short range signal suitable for stimulating the response of the mobile part and is connected to the apparatus or system to be enabled, for example belonging to the automotive field or to the building and/or like field.

The mobile part typically comprises an electronic circuit, an integrated two-way radio antenna and one or more power supply batteries; such components generally are received in small containers typically made of a plastic material.

Such known enabling and control devices, moreover, have very low operating power and frequency and as such, according to the standards for the protection of the users' health.

However, if the transponder-based enabling and control devices defined above must be used on multiple readers, they require fixed ciphering codes and methods, which is negative from the point of view of safety, as it would be easier to get to know said codes and moreover, they do not allow a direct data exchange between transponder and transponder and do not even allow limiting the introduction of new and further transponders to the memory of the reader without knowing beforehand which limitation will be required; such limitation is only possible based on preset data (for example from one serial number to another serial number of the transponder) and as a consequence, new instructions must be given to the reader to change the limitations.

A further disadvantage is represented by the fact that such transponder devices do not allow storing multiple codes and coding systems so as to be associated to different readers in a different manner.

A further disadvantage of traditional devices is represented by the fact that they do not allow recording and/or storing ancillary data to the transponder relating to the action carried out by the reader or ancillary data unrelated to recognition usable for different purposes.

### DISCLOSURE OF INVENTION

The object of this invention is to obviate the drawbacks mentioned hereinabove.

More in particular, the object of this invention is to provide an improved access identification and control device which should allow a storage procedure required for a subsequent recognition each time using a different data ciphering system which is composed of both a different ciphering algorithm and different ciphering keys.

A further object of this invention is to provide an identification and control device suitable for having a procedure for allowing the storage or the self-learning of a given transponder with a given reader (coupling function) without the need of communicating information or signals beforehand to the reader itself.

A further object of this invention is to provide an identification and control device suitable for allowing also direct transponder-transponder communication for example for exchanging data between the mobile parts (business cards and the like).

A further object of this invention is to provide an identification and control device suitable for allowing the recognition of multiple mobile devices held by the user.

A further object of this invention is to provide an identification and control device suitable for allowing the storage of multiple ciphering systems and codes to the transponder, enabling the user to have an entire bunch of keys in a single device.

A further object of this invention is to provide a device which should allow each user that manages an access to have different ciphering systems and codes for each user so as to enable access to authorised users only.

A further object is to provide a device that should allow storing and transmitting additional data relating to time and results of the operations carried out by both the mobile part and the fixed part with functions of proof (for example opening and closing time of a service) or personal identification data (for example business card, identity card, etc.).

A further object of the present invention is to provide a device with low operating power and frequency, low consumption and moreover, easy to use and suitable for guaranteeing a high resistance and reliability value over time, besides being easily and inexpensively constructed.

These and other objects are achieved by the access identification and control device of this invention which comprises at least one fixed part or reader and at least one mobile part or transponder that can communicate with each other in both directions, low power radio transmitters for carrying out said communication, a two-way radio antenna or element defined by the body of a user that constitutes an extension of the receiving antenna in the communication between fixed part and mobile part, the device wherein the fixed part and the mobile part comprise communication means defined by data ciphering algorithms and ciphering keys not known beforehand, each time different and suitable for identifying the mobile part only if the same has been previously stored to the reader or fixed part.

### BRIEF DESCRIPTION OF THE DRAWINGS

The construction and functional features of the access identification and control device of this invention shall be better understood from the following detailed description, wherein reference is made to the annexed drawings showing a preferred and non-limiting embodiment thereof, and wherein:

FIG. 1 shows an operating diagram of the identification and control device of this invention with reference to the fixed part thereof;

FIG. 2 shows an operating diagram of the identification and control device of this invention with reference to the mobile part thereof;

FIG. 3 shows a schematic example of the operation of the access identification and control device of this invention in the case of a procedure called “self-learning” (APR) automatically carried out in the presence of a remote signal;

FIG. 4 schematically shows an example of the operation of the device of the invention in the case of enabling of a transponder to activate a self-learning with a given reader (remote self-learning signal);

FIG. 5 shows an operating diagram of the device of the invention used whenever a reader must connect to one or more remote units;

FIG. 6 schematically shows a mode of using the device of the invention;

FIG. 7 schematically shows an exemplary use of the device of the invention.

### BEST MODE FOR CARRYING OUT THE INVENTION

The device of the invention, hereinafter described in detail with reference to the component elements thereof and their interaction for operation, comprises a mobile part defining the portable device which may be worn by the user or may be integrated in the device to be controlled (helmet, safety equipment, clothing, etc.) and a fixed part representing the device suitable for reading the mobile part or parts and consequent actuations in charge; the fixed part may be portable or transportable as well.

Each mobile part defines a personal “key” that may be associated to multiple fixed parts with different and unknown ciphering codes and modes; moreover, said mobile part may contain information of a different nature readable with systems with a different safety and may communicate with other mobile parts, in a direct manner or by means of bridge interfaces, so as to carry out an exchange of data of a different nature, such as for example personal documents, business cards and the like.

Each fixed part has the capability of reading a plurality of different mobile parts for carrying out not only the user enabling to access for example rooms, use equipment, etc. but also for verifying the presence of safety equipment (shoes, helmet, etc.) by the user.

Each fixed part may be applied to different mobile parts with communication algorithms and codes that are not known beforehand by the system or device manager; this implies some advantages in terms of safety.

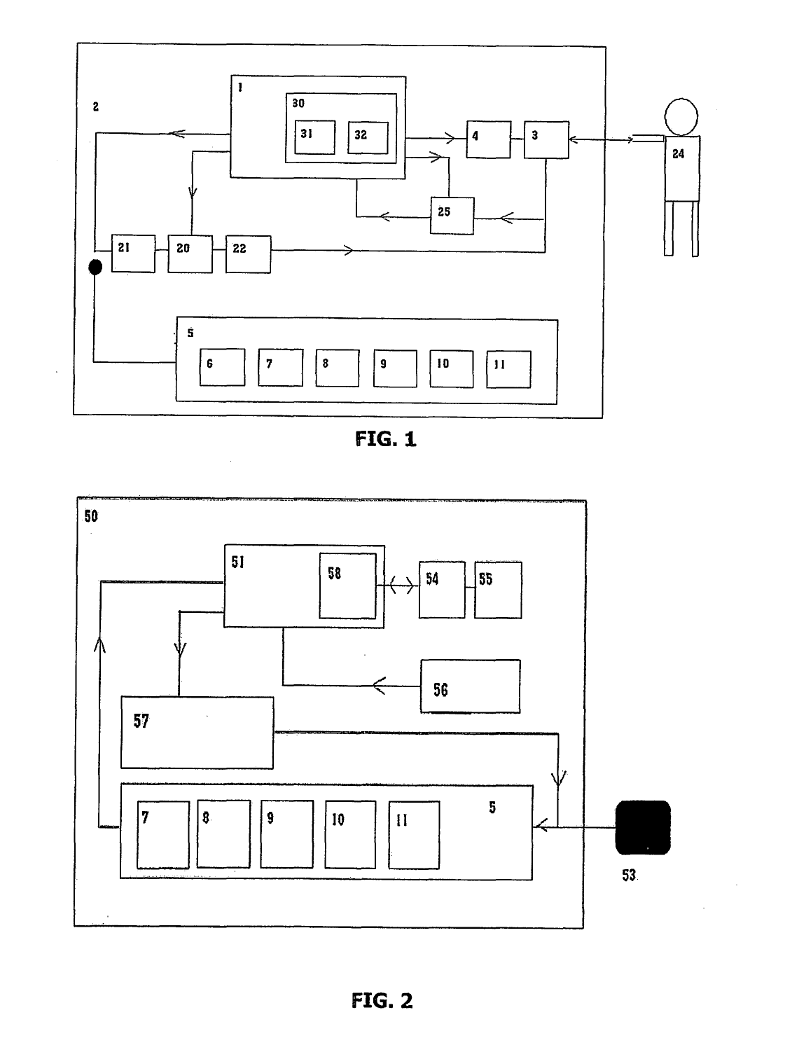

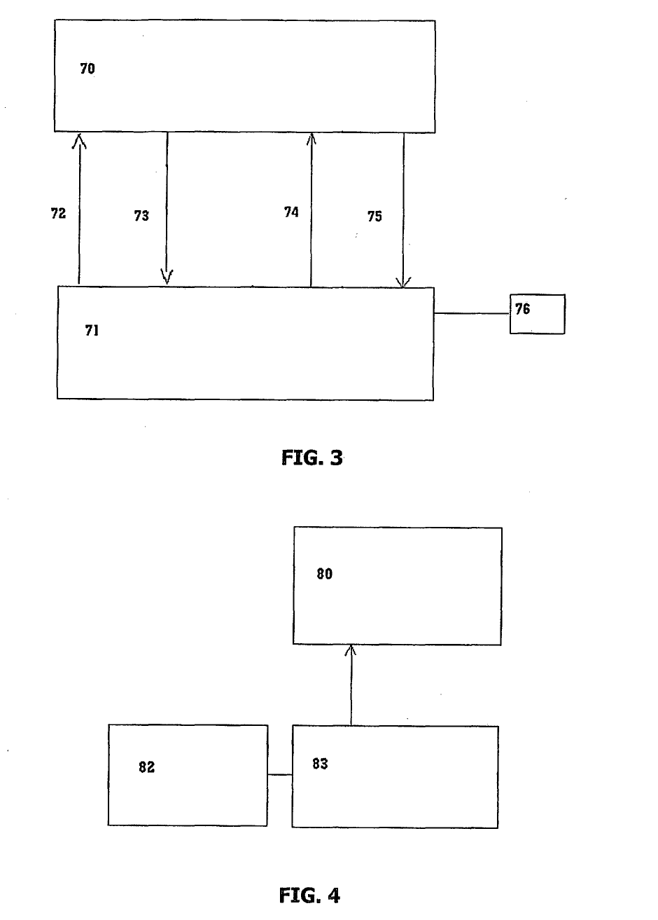

With reference to FIGS. 1 and 2, there is shown a preferred and non-limiting example wherein the device of the invention carries out the function of recognition of a transponder by a reader or fixed part; the device of the figures is preferably used in operations for enabling the opening of building, industrial or like doors, but also for transferring information (personal data, business card, etc.) or for checking the presence of any safety equipment (helmet, safety shoes, etc.).

A microprocessor 1 controls a series of electronic circuits that define the reader (or fixed part) indicated with 2 in the complex of FIG. 1. An electrode 3, when touched or stressed, energises a contact detection element 4 that sends the information of the occurred contact to microprocessor 1 which activates a transmission sending a radio frequency signal modulated according to known and conventional techniques and containing a data packet 5 suitable for being received by a mobile part or key” or transponder 50 represented in the diagram of FIG. 2.

The transmission in radio frequency mentioned above preferably takes place using an individual's body as conductor element and extension of the antenna; however, said transmission may also be carried out using any other known method.

The data packet 5 contains at least one serial number 6 for example of a lock, a control code 7 referred to a data reading control, a data integrity control code 8, a first random number 9, a second random number 10 and a third random number 11 generated at the time of start of the data transmission and having the function of public ciphering keys; said numbers and codes, with the exception of the third random number 11 are ciphered with a dedicated algorithm using the third random number 11 as ciphering key.

The fixed part 2 of the device of the invention further comprises an oscillator 20 modulated by a modulating circuit 21 typically of the on/off type by means of the data in output from microprocessor 1.

The fixed part 2, moreover, comprises a receiving block 25 the function whereof shall be described hereinafter.

The output from the modulating circuit 21 is amplified by a stage 22 and is connected through electrode 3, to a two-way radio antenna or element 24 preferably defined by the user's body.

The transmission generally lasts a few tenths of milliseconds and takes place using the traditional principle of conveyed waves or equivalent and known transmission methods.

With reference to FIG. 2, there are described the component elements of the mobile part of the device. In the mobile part 50 there is a block 5, which represents the same block 5 transmitted by the fixed part and now received by the mobile part.

If the mobile part 50 receives a signal in radio frequency, through an electrode 53, microprocessor 51 activates and carries out intermediate checks on incoming data and on the signal received for checking that it is a data packet coming from the fixed part 2 and intended for it, in order to deactivate if not interested in the complete reception of all the data to accomplish an energy saving and an optimisation of latency times. Once microprocessor 51 has assessed the validity of the data, it starts a checking process and after verifying that the control code 7 is a recognition request code, it carries out the decoding of the entire data packet 5 using a dedicated algorithm and the random number 11 that defines the ciphering key.

The serial number 6 of the lock or of the service to be enabled, the first random number 9 and the second random number 10 sent with the data packet 5 are obtained unencoded after such decoding process.

If the serial number 6 of the lock is already found in at least one memory unit 58 (subsequent to the self-learning process that shall be explained hereinafter), microprocessor 51 obtains contiguous memory locations associated to such serial number, a datum 54 containing a number defining a secret ciphering key and a datum 55 containing a further number suitable for determining the variation of the ciphering algorithm mentioned above.

The microprocessor 51 of the mobile part 50 of the device of the invention, at this point, can carry out three different procedures connected to one another, or if the serial number 6 of the lock is not already found in at least one memory unit 58, set up to the condition suitable for a new reception of the data packet 5 of the fixed part 2. The first procedure consists in ciphering a further serial number 56 of the mobile part 50 using a special algorithm and, as coding keys, the first random number 9 and the second random number 10 sent to the mobile part itself; a “basic serial number” is obtained subsequent to such operation.

The second procedure encrypts the further serial number 56 of the mobile part 50 by means of a dedicated algorithm modified based on the number of datum 55 which, as said above, causes the variation of the coding algorithm; the second procedure, moreover, uses the number comprised in datum 54 as coding key. The result of this operation is defined as “secret ciphering serial number”.

The third and last procedure adds the result of the first and second procedure to the two data packets, that is, the “basic ciphered serial number”, the “secret ciphering serial number” and any further ancillary data such as, for example, the charge level of the system power supply battery, etc.; a further ciphering is applied to the set of such new data packet through a dedicated algorithm. The parity check codes obtained with such third procedure are thus added to the global data packet which leads to obtaining a set of data defined by a block 57. Such data define the responses sent by the mobile part to the fixed part 2 (transponder function).

Once the data processing has ended, the microprocessor 51 after a delay, depending on a random number generated thereby, activates a transmission step sending, through the electrode 53 and the user's body or in other known manner, towards the fixed part 2, a radiofrequency signal modulated by the data block 57 according to known techniques. The transmission delay by microprocessor 51, which generally is a multiple of the time required for transmitting the data block 57 based on a delay in the transponder response based on a random or predetermined value, is intended for allowing the fixed part 2 to receive multiple signals coming for example from two or more transponders that respond to the same fixed part (anti-collision function).

At this point, the fixed part 2, that has ended the transmission step, deactivates the oscillator 20 and activates the receiving block 25.

The two-way radio antenna 24 is connected through electrode 3, to receiver 25; the microprocessor 1 analyses the signals coming from the receiver 25 constituting the data packet of block 57 of the mobile part 50.

Once the reception step has ended, the microprocessor 1 of the fixed part or reader carries out the same procedures of the mobile part in the reverse order; said procedures are indicated as reception procedures of the fixed part or reader 2.

A first reception procedure consists in a decoding operation using a dedicated algorithm (known to all the elements of the device) so as to obtain the two unencoded the two “basic ciphered serial number” and “secret ciphering serial number” packets obtained with the first and second procedure carried out in the mobile part 50 of the device of the invention.

A second reception procedure consists in carrying out a decoding operation that uses a further dedicated algorithm known to the elements constituting the device and moreover, uses the first random number 9 and the second random number 10 as decoding keys for the “basic ciphered serial number” data packet; this allows obtaining the further serial number 56 of the mobile part 50, unencoded.

A third reception procedure is articulated into two sub-procedures.

As regards the first one of said sub-procedures, if the further serial number 56 of the mobile part or key 50, that has sent the data to the fixed part by means of the receiver 25, is already present (subsequent to the self-learning process explained hereinafter) in at least one cell of a memory block 30 of the microprocessor 1, it extracts the data associated to the memory location wherein the further serial number 56 is stored, obtaining a number 32 that determines the variation of the ciphering algorithm and a number 31 that, on the other hand, defines the secret keys of said ciphering; such ciphering is only used by the mobile part 50 that has the serial number 56.

A decoding operation is thus carried out on the “secret ciphering serial number” packet using an algorithm modified by means of number 32 using number 31 as a key, obtaining the further number 56 of the mobile part or transponder 50 unencoded.

If the result of the second reception procedure and that of the first sub-procedure of the third reception procedure match, the operation ends with a recognition of the user and with the accomplishment of any actions required, such as opening a door or in general, enabling a service.

As regards the second sub-procedure of the third reception procedure, if the further serial number 56 of transponder 50 that has sent the data is not present in memory 30 of the reader itself, a decoding operation is carried out for the “secret ciphering serial number” through a dedicated procedure known by all the system elements, to check if the mobile part 50 has responded using a special code indicating a self-learning signal or APR (remote self-learning signal).

If the result of the second reception procedure and that of the second sub-procedure of the third reception procedure match, a further procedure starts which is indicated as transponder or mobile part self-learning procedure, which shall be explained hereinafter.

Upon any data storage, the access identification and control device of this invention assigns a different data ciphering algorithm and different secret keys required for coding/decoding, to both the transponder or mobile part 50 and to the reader or fixed part 2.

Moreover, it is possible to actuate a remote signal to self-learning with which a matching is created between transponder and reader wherein the secret codes are not transmitted, but temporary data not dedicated to the specific user entered by the device manager, which the reader or fixed part 2 can exchange with the mobile part 50 and which are modified upon the first use of the device by the user, and thus upon the enabling thereof.

Said self-learning is carried out by means of the “remote self-learning signal” procedure that enables a specific transponder to communicate with a specific reader while allowing maintaining the secrecy features of the transmitted codes (in fact, by virtue of the above the transmitted codes are not the actual ones used after the enabling); this is especially useful in the case, for example, of a car company that can provide the keys of a motor vehicle programming in advance temporary enabling codes, that is, only required to carry out the first operation of enabling the user to the service.

It should be noted that the transmission/reception process and as a consequence, the user recognition process takes place by the effect and at the time when the user him/herself touches the reader or a part thereof in charge of detecting the touch.

A preferred and non-limiting example is illustrated hereinafter with reference to FIGS. 1 and 2, wherein the device of the invention carries out the function of self-learning of a transponder by a reader or fixed part.

The reader carries out a procedure similar to that described before when explaining the recognition procedure of a transponder but in generating the data packet 5 relating to FIG. 1, it replaces code 7 (that in the recognition procedure was a reading command) with a self-learning command.

If the transponder 50 receives a radiofrequency signal containing the data packet 5 compatible with the system, the microprocessor 51 starts the checking process and decodes the data packet 5 with a dedicated algorithm. Following the verification that the control code 7 is a self-learning code, the microprocessor 51 records the serial number 6 of the reader to the memory 58 and in the contiguous locations the number contained in datum 54 as a copy of the first random number 9, the number contained in datum 55 as a copy of the second random number 10. If said serial number is already found in memory 58 of the microprocessor 51, a recording operation is carried out overwriting the memory allocations and carrying out the procedures mentioned above. In the reader or fixed part 2, once the step of transmission to the transponder 50 has ended, the oscillator 20 is deactivated and the reception block 25 is activated and the reception procedures already described above for the transponder recognition function are carried out.

In particular, the third reception procedure carries out the operation of decoding the “secret ciphering serial number” data packet using an algorithm modified by the first random number 9 and by the second random number 10 (used as decoding key) obtaining the unencoded serial number 56 of the transponder; the first random number 9 and the second random number 10 are known as they have been generated at the beginning of the self-learning procedure. If the result of the second reception procedure and that of the third reception procedure match, the self-learning operation outcome is positive and the numbers of data 54 and 55 associated to the serial number of the reader have been recorded to the memory 58 of microprocessor 51 of transponder 50. The microprocessor 1 of the fixed part 2 records the first random number 9, the second random number 10 and the serial number 56 of the key or transponder to some free memory locations; if the serial number 56 of the transponder that has sent the data is already found in memory 58 (as a result of a previous self-learning), then the recording operation is carried out overwriting the same memory locations. Such data contained in the memory of the fixed part 2 and in the memory of the mobile part 50 allow reader and transponder to recognise each other in a unique and safe manner using random coding/decoding algorithms and keys that are not transmitted again anymore, and thus cannot be reproduced or copied.

If the microprocessor 1 of the fixed part or reader 2 does not receive a response of data compatible with a self-learning procedure within a predetermined time and usually, a few tenths of milliseconds, it checks the status of the contact detection system 23 and if this is still active it repeats the procedure creating a first random number 9 and a second random number 10 again.

With reference to FIG. 3, there is shown a preferred and non-limiting example that can be used whenever the system must carry out a self-learning only in the presence of a remote signal (remote self-learning signal). With reference to said figure, the reader or fixed part indicated with 2 in the complex of FIG. 1 is here represented by a macro-block 71 and the transponder indicated with 50 in the complex of FIG. 2 is here represented by a macro-block 70.

The reader, actuated by a special control such as for example the touch of an electrode 76, requests a recognition to the transponder represented by a data flow 72 and if this responds with a data flow 73, using a special coding key (that indicates the remote self-learning signal), the reader checks the validity of the special key, starts a self-learning procedure for that specific transponder, indicated by flow 74 and by flow 75.

With reference to FIG. 4, there is shown an example of embodiment of the device of the invention that can be used whenever the transponder must be enabled to be stored (self-learning) on a given reader (remote self-learning signal) where the transponder, indicated with 50 in the complex of FIG. 2, is here globally represented by a block 80. A remote actuator, for example composed of a personal computer, 82 and an interface 83, sends a data flow to the transponder 80 that stores it; said data flow contains a special coding key calculated based on the serial number of the lock for which the storage will be allowed (“remote self-learning signal”).

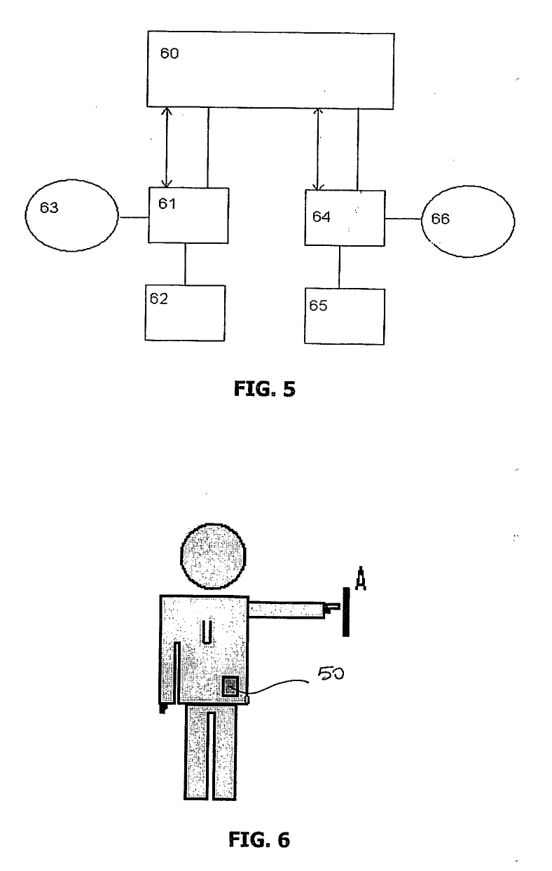

With reference to FIG. 5, there is shown a preferred and non-limiting example that can be used whenever a reader must be connected to one or more remote units, realising a system with multiple peripheral identification points, all using the codes stored to the reader, but that can be activated individually.

In the example of the figure, at least two remote units indicated with 63 and 66, connected to a reader 60 by a first electrical cable and a second electrical cable, respectively control a usage block 62 and 65. When a user actuates the system, for example by an electrode 63, the device 61 retransmits the actuation signal through the first cable to the reader 60.

The reader 60 starts a reading procedure of transponder, detailed above, using device 61 and electrode 63 and using the first cable for transferring the data to and from the device 61. Said device 61 therefore does not enable or store no data, it only serves as an intermediary towards the user. If a transponder is recognised, the reader 60 sends a signal through the first cable, for example for opening, which the device 61 launches to the usage block 62 connected thereto. The device 64 with the usage block 65, the electrode 66 and the cable 69 operate in a similar manner.

FIG. 6 schematically shows an exemplary use of the device of the invention wherein a user U has with him/her, for example in a pocket, the transponder 50 or mobile part, integrated in an equipment that can be of various types (building lock, car, medical, mechanical equipment, etc.).

The fixed part or reader is stimulated through the simple touch of the human body, that may be carried out by a touch system or other known and equivalent manner.

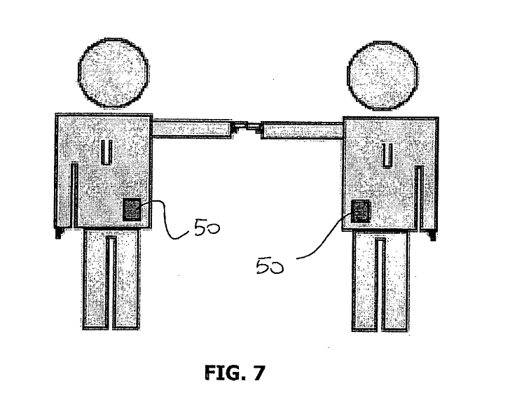

FIG. 7 schematically shows an exemplary use of the device of the invention wherein two users carrying, for example in a pocket, the transponder or mobile part 50, exchange some data of the type normally found on as business card, by a handshake or other way. As regards the operation, if the two transponders are programmed to carry out the above function or if said function is activated, for-example, by a button or a control switch located on the transponder itself, they transmit a special signal suitable for being received and interpreted by another transponder and interpreted as a data exchange request, after which it sets to reception.

The modulation methods and circuits described above can be used to carry out this function. This cycle, described by way of a non-limiting example, may be very short and transmitted many times in a second so as to be certainly received by the transponder of the other individual during a handshake. As soon as this signal has been received, the transponder transmits its data for example making up the contents of a business card that may be received by the requesting transponder set to reception.

The device of the invention is battery powered and in particular, the mobile part or transponder 50 communicates to the fixed part or reader 2 the level of charge of said battery; the fixed part, moreover, provides a sound and/or visual signal of the level of charge of the battery itself.

The same device, moreover, on the mobile or transponder part has some coloured light signalling elements (for example LEDs) suitable for indicating the operations occurred; in an alternative embodiment, the mobile part can be provided with a graphical display whereon the user can read the operations and/or the accesses made.

The communication between the fixed and mobile parts takes place, even in the lack of a direct contact between the parts themselves, by the use of radio waves, even though of a very limited range; this is to favour safety and prevent others from taking advantage of the service enabled by a user.

As can be noticed from the above, the advantages achieved by the device of the invention are clear.

The access identification and control device of this invention can advantageously be used for checking an access code, a partial authorisation (for example time, daily, directional and the like), an available credit or for enabling particular equipment or clothing that incorporate a mobile part. The device of the invention may found application in the control devices for the activation of electrically controlled apparatus, such as for example the control devices of electromechanical actuators, the devices for switching on motor vehicles and vehicles in general, the devices for controlling the access to hazardous zones or to areas reserved to the entrance of certain categories of people, the devices for enabling the use of equipment, weapons and/or other types of service.

The identification and control device of the invention is advantageously usable to control reserved accesses, that is, to control the entrances of both living and industrial buildings, in the form of enabling the lock-release function of the electromagnetic systems that control the opening/closing of the locks of some buildings; such access control is applicable, as said above, also to the function of lock/release of some motor vehicles (wheel lock/release, steering lock, brake control, etc.).

A further advantage is the fact that the mobile parts or transponder of the device of the invention can advantageously record and/or store ancillary data relating to the time and/or results of the actions carried out by the reader or ancillary data unrelated to recognition usable for different purposes; in this way, the device serves as a “black box” of portable type that stores all the operations carried out by the user. The subject data can be stored to memory cells internal to the processor itself of the transponder when a high safety degree is required, or to a special memory external to the processor but connected thereto and managed thereby if a large amount of data must be stored.

The device of the invention therefore allows having a different unique key for each user and such as to allow the one or more transponders or mobile units to store a plurality of coding systems and codes to associate to different readers in a different manner, thus allowing the user to have a whole bunch of keys in a single device.

A further advantage is that the fixed part may be connected by any method to the apparatus to be enabled whereas the mobile part may be worn by the user (applied to the clothes or put in a pocket) or inserted in accessories such as bags, wallets etc. with the mobile parts that can exchange data both in the presence of an external excitation and in an autonomous manner; the use of radio waves, while of very limited range, allows the communication between the parts even in the lack of a direct contact between the parts themselves.

A further advantage is represented by the fact that the self-learning function allows guaranteeing a high safety factor, since the exchange codes between the fixed part and the mobile part required for the recognition of the mobile part and preliminary to the assignment of the final codes are not known beforehand and are not known by the operator of the service offered by the device.

A further advantage is that the self-learning or storage procedure allows, if required by the user, to store the access data in an automated manner; if such request is not made by the user, the same procedure may be activated operating on the fixed part or reader with any known means, such as for example a hidden button, a secret code, an already recorded transponder, etc.

A further advantage is that the mobile part or transponder carries out intermediate checks on the data and on the signal received by the fixed part in order to deactivate if not interested in the complete reception of all data; this allows obtaining an energy saving besides an optimisation of the latency times.

A further advantage is the fact that since the device of the invention uses the principle of conveyed waves, normally carried by the user's body, it allows an optimum operation even with radiated power so low as to not allow a transmission to free air greater than a few tenths of centimetres; the access selection is limited and ensured to who is wearing the mobile part.

A further advantage is that the device of the invention uses a data anti-collision system based on a delayed response of the transponder to a random or predetermined value.

A further advantage is that the device of the invention is powered by at least one low voltage battery that allows an extended use thereof considering that the device of the invention has a very low consumption.

While the invention has been described hereinbefore with particular reference to an embodiment thereof made by way of a non-limiting example only, further changes and variations will appear clearly to a man skilled in the art in the light of the above description. This invention therefore is intended to include any changes and variations thereof falling within the spirit and the scope of the following claims.

1. An access identification and control device, especially suitable for being used for all those applications wherein the use of an apparatus or a service must be allowed only to the users that have the requirements imposed by the apparatus/service itself or if a check must be carried out on an apparatus or service, comprising at least one fixed part or reader (2) and at least one mobile part or transponder (50) that can communicate with each other in both directions, low power radio transmitters for carrying out said communication, a two-way radio antenna or element (24) defined by the body of a user that constitutes an extension of the receiving antenna in the communication between fixed part and mobile part, the device being characterised in that the fixed part (2) and the mobile part (50) comprise communication means defined by data ciphering algorithms and ciphering keys not known beforehand, each time different and suitable for identifying the mobile part (50) only if the same has been previously stored to the reader or fixed part (2).

2. The identification and control device according to claim 1, which further comprises a storage or self-learning procedure, of a given transponder (50) with a given reader (2), with said procedure that enables the transponder (50) to communicate with the reader (2) using temporary data, not dedicated to the specific user and such as to not require the prior communication of information and signals to the reader itself.

3. The identification and control device according to claim 1, wherein the reader or fixed part (2) provides to the recognition of one or more transponders or mobile part (50) by means of a data anti-collision function based on a delayed response of the transponder based on a random or predetermined value.

4. The identification and control device according to claim 1, wherein each mobile part of transponder (50) stores multiple codes and coding systems suitable for being associated to one or more fixed parts (2) so as to concentrate a plurality of keys in the device and provide to the recognition of multiple mobile pieces of equipment.

5. The identification and control device according to claim 1, wherein the recognition of the transponder (50) by the reader (2) is carried out by means of a data packet (5), transmitted by the fixed part to the mobile part and such as to travel on a radiofrequency signal at a very low rate activated by a microprocessor (1) of the fixed part (2) when an information of the occurred contact of the user with an electrode (3) is sent by a contact detection element (4) to the microprocessor (1).

6. The identification and control device according to claim 5, wherein the data packet (5) comprises at least one serial number (6), a control code (7), a data integrity control code (8), a first random number (9), a second random number (10) and a third random number (11) generated at the beginning of the transmission process from the reader (2) to the transponder (50).

7. The identification and control device according to claim 6, wherein the data packet (5) is received by the mobile part or transponder (50) by means of an electrode (53), with said mobile part that comprises a microprocessor (51) suitable for checking the control code (7) and processing and decoding the date packet (5) by a dedicated algorithm and the random number (11) so as to obtain the unencoded serial number (6) of the lock, the first random number (9) and the second random number (10).

8. The identification and control device according to claim 7, wherein the reader or fixed part (2) comprises and oscillator (20), a modulating circuit (21) suitable for modulating the oscillator (20) and a receiving block (25).

9. The identification and control device according to claim 8, wherein the microprocessor (51) of the mobile part or transponder (50) carries out intermediate checks on the incoming data and on the signal received for verifying that it is a data packet coming from the fixed part and carries out a sequence of procedures for processing data wherein:
a serial number (56) of the mobile part or transponder (50) is ciphered by a dedicated algorithm with the first random number (9) and the second random number (10) used as coding keys for obtaining a “basic ciphering serial number”;
the further serial number (56) is encrypted by a dedicated algorithm modified by a datum (55) obtaining a “secret ciphering serial number”;
further ancillary data are added to the “basic serial number” and to the “secret ciphering serial number”, a further ciphering by a dedicated algorithm and parity check codes for obtaining a block (57) containing the responses sent by the mobile part (50) to the fixed part (2); or
said microprocessor (51) sets up to the suitable condition for a new reception of the data packet (5) of the fixed part (2) if the serial number (6) is not already found in at least one memory unit (58).

10. The identification and control device according to claim 9, wherein the microprocessor (1) of the fixed part or reader (50), at the end of the transmission step from the reader or fixed part (2) to the transponder or mobile part (50), carries out a sequence of reception procedures comprising:
a decoding operation, by a dedicated algorithm, suitable for obtaining the two “basic ciphering serial number” and “secret ciphering serial number” packets encoded;
a decoding operation, by a further dedicated algorithm and the first random number (9) and the second random number (10) suitable for obtaining the further serial number (56) of the mobile part (50);
an operation of data extraction associated to a memory location of a memory block (30) of the microprocessor (1) of the fixed part (2) wherein the further serial number (56) is stored for obtaining a number (32) suitable for determining the variation of the ciphering algorithm and a number (31) suitable for defining the secret keys of such ciphering;
an operation for decoding the “secret ciphering serial number”, for obtaining the further unencoded serial number (56), by an algorithm modified by the number (32) and the number (31); or
an operation for decoding the “secret ciphering serial number”, for verifying if the mobile part or transponder (50) has responded using the self-learning procedure.

11. The identification and control device according to claim 9, wherein the self-learning storage procedure comprises the steps of:
generating a data packet (5) that replaces the code (7) with a self-learning command.
sending a radiofrequency signal to the transponder (50) containing the data packet (5) of the reader or fixed part (2);
checking and decoding the data packet (5) by the microprocessor (51) of the transponder (50) and checking that the control code (7) is a self-learning code;
recording the serial number (6) of the reader of fixed part (2) to a memory (58) of the microprocessor (51) and recording the number contained in datum (54) to contiguous memory locations as a copy of the first random number (9) and of the number contained in datum (55) as a copy of the second random number (10);
activating the receiving block (25) of the reader or fixed part (2);
decoding the “secret ciphering serial number” by an algorithm modified by the first random number (9) and by the second random number (10) generated at the beginning for the procedure for obtaining the unencoded serial number (56) of the transponder (50);
checking the status of a contact detection system (23) if the reader of fixed part (2) does not receive data compatible with the self-learning procedure and creating a new first random number (9) and a second random number (10).

12. The identification and control device to claim 1, wherein the transponder or mobile part is enabled to be stored to a given reader with a self-learning procedure wherein a remote actuator composed of a personal computer (82) and an interface (83) sends a data flow to the transponder with said data flow that contains a coding key calculated based on the serial number of the service for which storage is allowed.

13. The identification and control device to claim 1, wherein the reader or fixed part (2) is connected to one or more remote units (63, 66) for making a system with a plurality of peripheral identification points that use codes stored to the reader or fixed part and that can be activated individually.

14. The identification and control device to claim 1, wherein the mobile part or transponder (50) comprises coloured light signalling elements suitable for indicating the occurrence of the operations.

15. The identification and control device to claim 1, wherein the mobile part has a graphical display whereon the user reads the operations and/or the accesses carried out.
